(19) United States
(12) Patent Application Publication
(10) Pub. No.: US 2016/0305373 A1
(43) Pub. Date: Oct. 20, 2016

(54) MULTI-CYLINDER ENGINE

(71) Applicant: Electro-Motive Diesel, Inc., La Grange, IL (US)

(72) Inventors: Reddy Pocha Siva Sankara, Naperville, IL (US); Sudarshan K. Loya, Naperville, IL (US); Adarsh Gopinathan Nair, Darien, IL (US); Michael B. Goetzke, Orland Park, IL (US); Vijaya Kumar, Naperville, IL (US)

(73) Assignee: Electro-Motive Diesel, Inc., La Grange, IL (US)

(21) Appl. No.: 15/194,989

(22) Filed: Jun. 28, 2016

(51) Int. Cl. F02M 26/19; F02M 26/51

(52) U.S. Cl. CPC F02M 26/19; F02M 26/51

(57) ABSTRACT

A multi-cylinder engine including a donor cylinder, a non-donor cylinder, at least one intake manifold, and at least one camshaft is provided. An intake valve of the donor cylinder controls a flow of air into the donor cylinder. The donor cylinder fluidly communicates exhaust gases to an exhaust gas recirculation (EGR) system. An intake valve of the non-donor cylinder controls a flow of air into the non-donor cylinder. The at least one camshaft controls an opening and closing of the intake valve of the non-donor cylinder such that the intake valve of the non-donor cylinder is maintained open for a first intake duration. The at least one camshaft controls an opening and closing of the intake valve of the donor cylinder such that the at least one intake valve of the donor cylinder is maintained open for a second intake duration which is greater than the first intake duration.

### TECHNICAL FIELD

The present disclosure relates to engines associated with exhaust gas recirculation (EGR) systems. More particularly, the present disclosure relates to a multi-cylinder engine having a CAM timing associated with various CAM profiles like miller cycle, Atkinson cycle, and the like.

### BACKGROUND

Internal combustion engines typically combust a mixture of air and fuel using one or more engine cylinders for generating mechanical power. Exhaust gases are emitted into atmosphere from each of the engine cylinders because of combustion process, The stream of exhaust gases may contain emissions such as unburned fuel, soot, nitrous oxide (NOₓ), carbon dioxide (CO₂) and carbon monoxide (CO). Engines are required to meet stringent emission standards to limit the emissions that the engine may discharge into the atmosphere. Various engine manufacturers have been incorporating Exhaust Gas Recirculation (EGR) systems in engines to comply with the emission standards. The EGR system facilitates recirculation of a portion of the exhaust gases back into an intake manifold of the engine so that the recirculated exhaust gases mix with a fresh stream of air intake.

Where a multi-cylinder engine incorporates an EGR system, manufacturers typically designate one or more cylinders as “donor” cylinders, while the remaining cylinders are designated as “non-donor” cylinders. The donor cylinders donate at least some part of the exhaust gases to the EGR system for the purpose of recirculation. In contrast, the exhaust gases from the non-donor cylinders may be directed to a turbine of the turbocharger or an aftertreatment system, thereby bypassing the EGR system This prevents back-pressure in the non-donor cylinders, as most of the exhaust gases are expelled out of the non-donor cylinders.

Although the aforementioned setup may prevent high back-pressure from the exhaust gases in the non-donor cylinders, the donor cylinders would continue to experience high back-pressure. High back-pressure may force a portion of the exhaust gases to remain inside the donor cylinders. Presence of the back-pressure may reduce the air intake as a portion of the exhaust gases remain inside the donor cylinders. The high temperature of the residual exhaust gases in the cylinder combined with low temperature of the incoming fresh air increases the temperature of the mixture for the combustion during next cycle. Subsequently emissions are also increased. Due to the back-pressure, the donor cylinders consequently become pre-occupied, at least in part, by the exhaust gases remnant or left behind. The donor cylinders may therefore receive a lesser amount of fresh air as compared to the non-donor cylinders. This reduces the air fuel ratio required for combustion. In some cases, the donor cylinders may receive, for example. 10% to 15% lesser fresh air as compared to the non-donor cylinders. Thus, the donor cylinders may have higher emissions than the non-donor cylinders for same engine operating conditions.

In order to reduce the high emissions, tuning of the donor cylinders may be performed differently from that of the non-donor cylinders. Numerous electronic systems exist in the art to control an operation of the donor cylinders and the non-donor cylinders separate from one another. However, these electronic systems may be complex, unreliable, and expensive to implement. Hence, there is a need for an improved, simplified, reliable, and cost-effective method that overcomes the aforementioned shortcomings when used in conjunction with an EGR system.

### SUMMARY OF THE DISCLOSURE

In an aspect of the present disclosure, a multi-cylinder engine includes a donor cylinder, a non-donor cylinder, at least one intake manifold, and at least one camshaft. The donor cylinder includes an intake valve that operatively controls a flow of air into the donor cylinder. The donor cylinder fluidly communicates exhaust gases to an exhaust gas recirculation (EGR) system. The non-donor cylinder includes an intake valve that operatively controls a flow of air into the non-donor cylinder. The at least one intake manifold directs air into the donor cylinder and the non-donor cylinder. The at least one intake manifold is disposed in fluid communication with the EGR system. The at least one camshaft controls an opening and closing of the intake valve of the non-donor cylinder such that the intake valve of the non-donor cylinder is maintained open for a first intake duration. In addition, the at least one camshaft controls an opening and closing of the intake valve of the donor cylinder, The at least one intake valve of the donor cylinder is open for a second intake duration. The second intake duration is greater than the first intake duration associated with the opening of the non-donor cylinder.

Other features and aspects of this disclosure will be apparent from the following description and the accompanying drawings.

### BRIEF DESCRIPTION OF THE DRAWINGS

FIG. 1 is a schematic of an exemplary engine system including an engine and an exhaust gas recirculation (EGR) system, according to the concepts of the present disclosure;

FIG. 2 is a graph depicting intake durations of an intake valve associated with a donor cylinder and an intake valve associated with a non-donor cylinder of the exemplary engine, according to the concepts of the present disclosure;

FIG. 3 is a graph showing a comparison of typical air fuel ratio (AFR) response curves for the donor cylinder including the intake valve with modified CAM timing and a typical donor cylinder including an intake valve with conventional CAM timing, according to the concepts of the present disclosure; and

FIG. 4 is a graph showing a comparison of exhaust temperatures in the donor cylinder having the intake valve with modified CAM timing and the typical donor cylinder having the intake valve with the conventional CAM timing, according to the concepts of the present disclosure.

### DETAILED DESCRIPTION

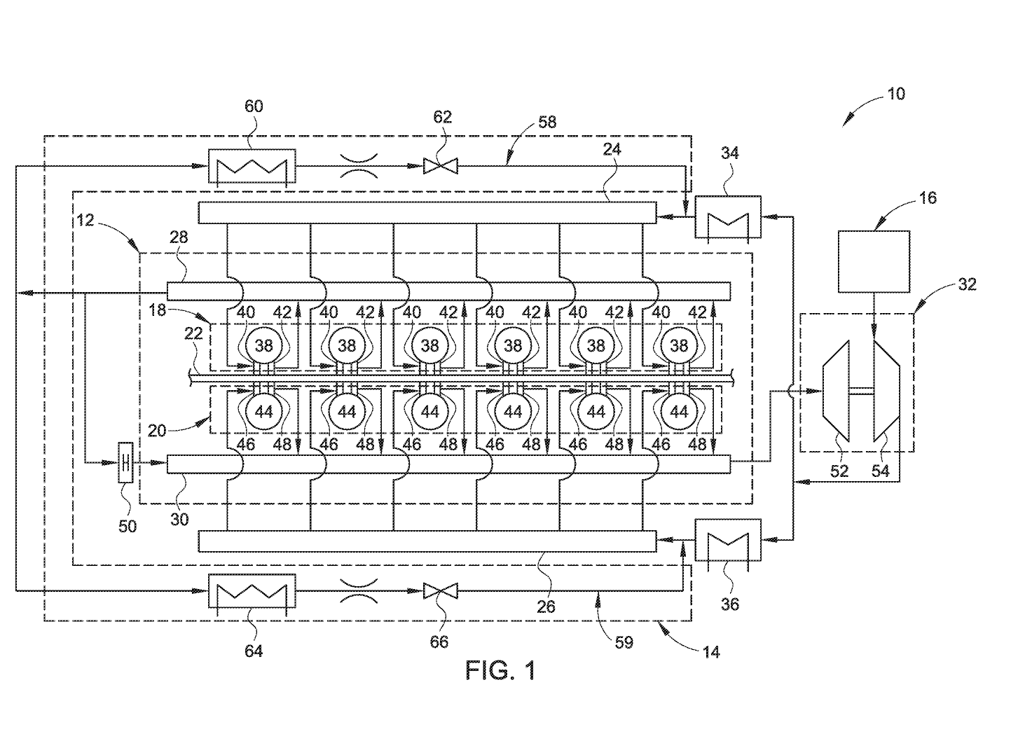

FIG. 1 shows an exemplary engine system 10 for a machine (not shown). The engine system 10 includes a multi-cylinder engine 12, an exhaust gas recirculation (EGR) system 14, and an air intake system 16. The multi-cylinder engine 12 will be hereinafter referred to as the engine 12.

The disclosed engine system 10 may find particular applicability with locomotives that may typically be subject to large variations in load. In embodiments herein, it may he contemplated to embody the engine 12 in the form of a four-stroke diesel engine, a four-stroke gasoline engine, or four-stroke gaseous-fuel-powered engine. The engine 12 includes a first cylinder bank 18, a second cylinder bank 20, at least one camshaft 22, a first intake manifold 24, a second intake manifold 26, a first exhaust manifold 28, a second exhaust manifold 30, a turbocharger 32, a first aftercooler 34, and a second aftercooler 36.

The first cylinder bank 18 includes six donor cylinders 38. Although, FIG. 1 depicts the first cylinder bank 18 with six donor cylinders 38, it may he contemplated include fewer or more number of donor cylinders 38 in the first cylinder bank 18. A number of donor cylinders 38 may vary from one application to another depending on specific requirements of an application. The donor cylinder 38 fluidly communicates some or all of exhaust gases to the EGR system 14 for recirculation. Although the disclosed embodiment of FIG. 1 shows the first cylinder bank 18 including only donor cylinders 38, in other embodiments, it can be contemplated to configure the first cylinder bank 18 such that the first cylinder bank 18 contains both non-donor cylinders 44 and donor cylinders 38.

Each of the donor cylinders 38 includes a cylinder head (not shown). The cylinder head (not shown) includes an intake valve 40 and an exhaust valve 42. The camshaft 22 mechanically actuates each of the intake valve 40 and the exhaust valve 42 to operate an open position and a closed position. The intake valve 40 operatively controls a flow of air into the donor cylinder 38. In the open position, the intake valve 40 allows the flow of air from the first intake manifold 24 to the associated donor cylinder 38. The air combusts with the fuel inside the donor cylinder 38 to produce exhaust gases. The exhaust gases are expelled through the exhaust valve 42 when the exhaust valve 42 is maintained in the open position by the camshaft 22. Downstream of the exhaust valve 42, the exhaust gases of the donor cylinder 38 flow to the first exhaust manifold 28. In the closed position, the intake valve 40 and the exhaust valve 42 block fluid communication of the donor cylinder 38 with the first intake manifold 24 and the first exhaust manifold 28 respectively.

The second cylinder bank 20 is located downstream of the second intake manifold 26 and upstream of the second exhaust manifold 30. The second cylinder bank 20 includes six non-donor cylinders 44. Although the disclosed embodiment of FIG. 1 shows the second cylinder bank 20 including only non-donor cylinders 44, it is also contemplated that second cylinder hank 20 may include both the non-donor cylinders 44 and the donor cylinders 38. As used in this disclosure, all the exhaust gases from the non-donor cylinder 44 are discharged to the turbocharger 32 and do not flow to the EGR system 14,

Each of the non-donor cylinders 44 includes an intake valve 46 and an exhaust valve 48 to control flow of air and exhaust gases. The intake valve 46 operatively controls a flow of air into the non-donor cylinder 44. In the closed position, the intake valve 46 and the exhaust valve 48 block fluid communication of the non-donor cylinder 44 with the second intake manifold 26 and the second exhaust manifold 30 respectively. When maintained by the camshaft 22 in the open position, the intake valve 46 allows the flow of air from the second intake manifold 26 to the associated non-donor cylinder 44. This way, the exhaust gases produced during combustion can be expelled through the exhaust valve 48. Downstream of the exhaust valve 48, the exhaust gases of the non-donor cylinder 44 flow to the second exhaust manifold 30, and thereafter to the turbocharger 32.

The turbocharger 32 is disposed in fluid communication with the second exhaust manifold 30 and hence, receives the exhaust gases from the second exhaust manifold 30, The turbocharger 32 includes a turbine 52 and a compressor 54. The turbine 52 is rotatably coupled to the compressor 54. The exhaust gases exiting the second exhaust manifold 30 move downstream and expand in the turbine 52. Expansion of the exhaust gases in the turbine 52 rotates the turbine 52 and hence, rotatively drives the compressor 54 that is in fluid communication with the air intake system 16. Although the engine system 10 shows only one turbocharger in here, the engine system 10 may use multiple turbocharging system connected in series or parallel as per requirement.

The camshaft 22 mechanically actuates opening and closing of each of the intake valves 40, 46 and each of the exhaust valves 42, 48. The camshaft 22 may operatively engage a crankshaft (not shown) in any manner known to persons skilled in the art such that a rotation of the crankshaft causes a corresponding rotation of the camshaft 22. As disclosed in FIG. 1, the engine 12 is shown including a single camshaft 22. However, the present disclosure contemplates use of more than one camshaft 22 in alternative embodiments. The camshaft 22 includes a number of lobes, namely a donor intake lobe (not shown), a donor exhaust lobe (not shown), a non-donor intake lobe (not shown), and a non-donor exhaust lobe (not shown). A number of lobes used on the camshaft 22 may vary depending on the specific engine configuration used. Cam profiles of the lobes may determine, at least in part, an actuation timing and lift profile of each of the valves 40, 42, 46, 48 during operation of the engine 12. The donor intake lobe actuates the opening and closing of the intake valve 40 of the corresponding donor cylinder 38. The donor exhaust lobe actuates the opening and closing of the exhaust valve 42 of the corresponding donor cylinder 38. Similarly, the non-donor intake lobe actuates the opening and closing of the intake valve 46 of the corresponding non-donor cylinder 44. The non-donor exhaust lobe actuates the opening and closing of the exhaust valve 48 of the corresponding non-donor cylinder 44.

In the disclosed camshaft 22, the donor intake lobe is configured to exhibit a different cam profile as compared to the cam profile of the non-donor intake lobe. When the camshaft 22 rotates, the non-donor intake lobe opens and closes the intake valve 46 of the non-donor cylinder 44, such that the intake valve 46 of the non-donor cylinder 44 is open for a first intake duration. The first intake duration may correspond to a conventional CAM timing for the non-donor cylinder 44. The donor intake lobe opens and closes the intake valve 40 of the donor cylinder 38, such that the intake valve 40 of the donor cylinder 38 is maintained open for a second intake duration. The camshaft 22 is designed to lift the intake valve 40 of the donor cylinder 38, for example, according to a late-closing CAM cycle. Based on the late-closing CAM cycle, the intake valve 40 of the donor cylinder 38 remains opens for the second intake duration which corresponds to a modified CAM timing in accordance with embodiments of this disclosure. The modified CAM timing associated with the donor cylinder 38 is longer in duration compared to the CAM timing for the non-donor cylinder 44. This implies that the second intake duration is greater the first intake duration. Hence, the intake valve 40 of the donor cylinder 38 is maintained open for a longer duration as compared to the intake valve 46 of the non-donor cylinder 44. This allows an increased amount of air to flow into the donor cylinder 38 as compared to the non-donor cylinder 44 such that both the donor cylinders 38 and the non-donor cylinders 44 receive a uniform amount of air.

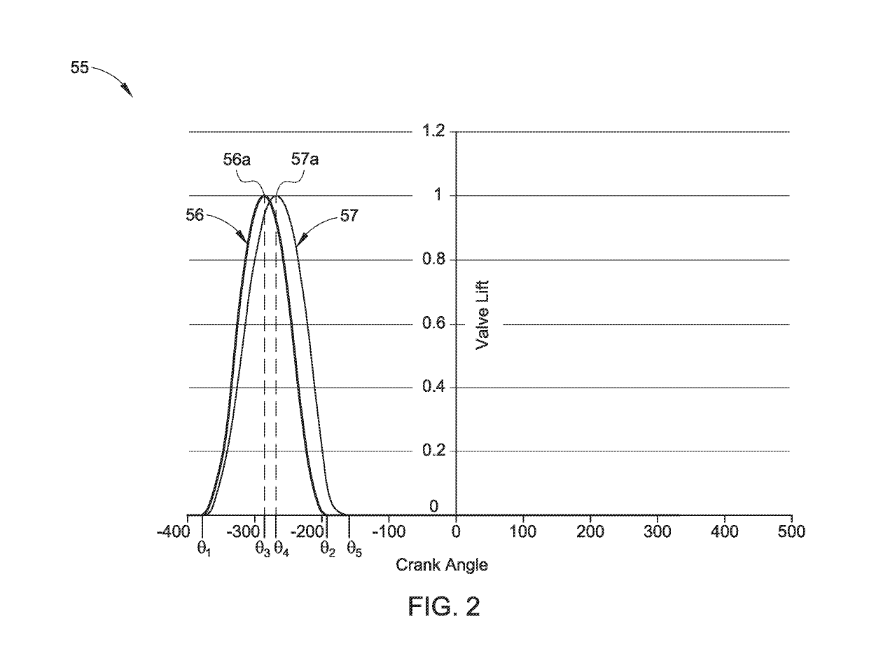

FIG. 2. shows a graph 55 depicting crank angle plotted against normalized valve lift of the intake valve 40 of the donor cylinder 38 and the intake valve 46 of the non-donor cylinder 44. An x-axis of the graph 55 shows the crank angle (in degrees). A y-axis of the graph 55 shows the normalized valve lift for the intake valves 40 and 46, associated with the donor cylinder 38 and the non-donor cylinder 44, respectively. FIG. 2 plots a first curve 56 and a second curve 57. The first curve 56 depicts the opening and closing of the intake valve 46 associated with the non-donor cylinder 44. The first curve 56 represents various positions of the intake valve 46 between the open position and the closed position. Similarly, the second curve 57 depicts the opening and closing of the intake valve 40 associated with the donor cylinder 38. The second curve 57 represents various positions of the intake valve 40 between the open position and the closed position. Further, the first curve 56 and the second curve 57 show the valve lift of the intake valve 46 and the intake valve 40, respectively, at different crank angles, while the intake valve 46 and the intake valve 40 are open. Horizontal distance between cranks angles for opening and closing of the intake valves 40 and 46 is referred as intake duration for the corresponding intake valves 40 and 46.

Referring to the first curve 56, the intake valve 46 of the non-donor cylinder 44 opens at a crank angle θ₁ and closes at a crank angle θ₂. A point 56a on the first curve 56 depicts a maximum valve lift of the intake valve 46 at a crank angle θ₃. The intake valve 46 remains open between the crank angle θ₁ and the crank angle θ₂, thereby determining the first intake duration corresponding to the CAM timing. In reference with the second curve 57, the intake valve 40 of the donor cylinder 38 opens at the crank angle θ₁, which is at a same time as that of the intake valve 46 of the non-donor cylinder 44. The intake valve 40 lifts and travels to reach a maximum valve lift at a crank angle θ₄. The maximum valve lift of the intake valve 40 at the crank angle θ₄ is depicted by a point 57a on the second curve 57. However, the intake valve 40 of the donor cylinder 38 closes at a crank angle θ₅, which is in time ahead of the crank angle θ₂ (at which the intake valve 46 of the non-donor cylinder 44 closes). The intake valve 40 remains open between the crank angle θ₁ and the crank angle θ₅, thereby determining the second intake duration corresponding to the modified CAM timing. As seen from the graph 55, the intake valve 40 of the donor cylinder 38 opens for a longer intake duration as compared to the intake duration of the intake valve 46 of the non-donor cylinder 44. Hence, the second intake duration for the intake valve 40 of the donor cylinder 38 is greater than the first intake duration for the intake valve 46 of the non-donor cylinder 44. This facilitates a uniform mass flow rate of air to each of the donor cylinder 38 and the non-donor cylinder 44.

In this disclosure, the donor intake lobe of the camshaft 22 is designed to open the intake valve 40 for the second intake duration which, as disclosed earlier herein, is longer in duration than the first intake duration associated with the non-donor cylinders 44. In general, the modified CAM timing for the intake valves 40 can be accomplished in any manner known to persons skilled in the art, including, but not limited to, the addition of devices and actuators that act on valve pushrods (not shown) to keep the respective intake valve open for a prolonged period. In an alternative embodiment, one or more actuators may be associated with the intake valves 40 of the donor cylinders 38. The actuators may be electrically actuated, hydraulically actuated, or may embody any type of device that is capable of acting on the valve pushrods to hold the respective intake valve open and vary a valve timing of the intake valve 40.

Referring to FIG. 1, during operation, the air intake system 16 facilitates delivery of the air to the first intake manifold 24 and the second intake manifold 26. The air intake system 16 draws air and delivers the drawn air to the compressor 54 of the turbocharger 32. The compressor 54 may be rotatively driven by the turbine 52 to compress the drawn air and direct the compressed air to the first aftercooler 34 and the second afiercooler 36. Each of the first aftercooler 34 and the second aftercooler 36 is configured to cool the compressed air and deliver the cooled air to the first intake manifold 24 and the second intake manifold 26 respectively. It is contemplated that the engine systems having multiple turbochargers may be equipped with one or more intercoolers or multiple aftercoolers.

Exhaust gases from the first cylinder bank 18 and the second cylinder bank 20 are discharged into the first exhaust manifold 28 and the second exhaust manifold 30 respectively. The first exhaust manifold 28 directs the stream of exhaust gases to the EGR system 14. Downstream of the first exhaust manifold 28, a portion of the exhaust gases from the first cylinder bank 18 may flow to the second exhaust manifold 30 via a flow restriction orifice 50 that is positioned between the first exhaust manifold 28 and the second exhaust manifold 30. The second exhaust manifold 30 receives the exhaust gases from the non-donor cylinders 44 and delivers the received exhaust gases to the turbine 52 of the turbocharger 32.

The EGR system 14 includes a first EGR circuit 58 and a second EGR circuit 59. Downstream of the first exhaust manifold 28, the exhaust gases split into a first portion and a second portion that flow to the first EGR circuit 58 and the second EGR circuit 59 respectively. The first EGR circuit 58 includes a first EGR cooler 60 and a first EGR valve 62. The first portion of the exhaust gases is cooled in the first EGR cooler 60 and thereafter, flows to the first intake manifold 24 via the first EGR valve 62. The second EGR circuit 59 includes a second EGR cooler 64 and a second EGR valve 66. The second portion of the exhaust gases is cooled in the second EGR cooler 64 and thereafter. flows to the second intake manifold 26 via the second EGR valve 66. It is contemplated that above mentioned configuration can be also applied for single or multiple path EGR systems.

The first intake manifold 24 and the second intake manifold 26 receive the exhaust gases from the EGR system 14. The exhaust gases mix with a fresh charge of air that is received from the air intake system 16 to result in an air-exhaust mixture in the first intake manifold 24 and the second intake manifold 26. The first intake manifold 24 and the second intake manifold 26 provide the air-exhaust mixture to the first cylinder bank 18 and the second cylinder bank 20 respectively during subsequent combustion cycles of the engine 12.

### INDUSTRIAL APPLICABILITY

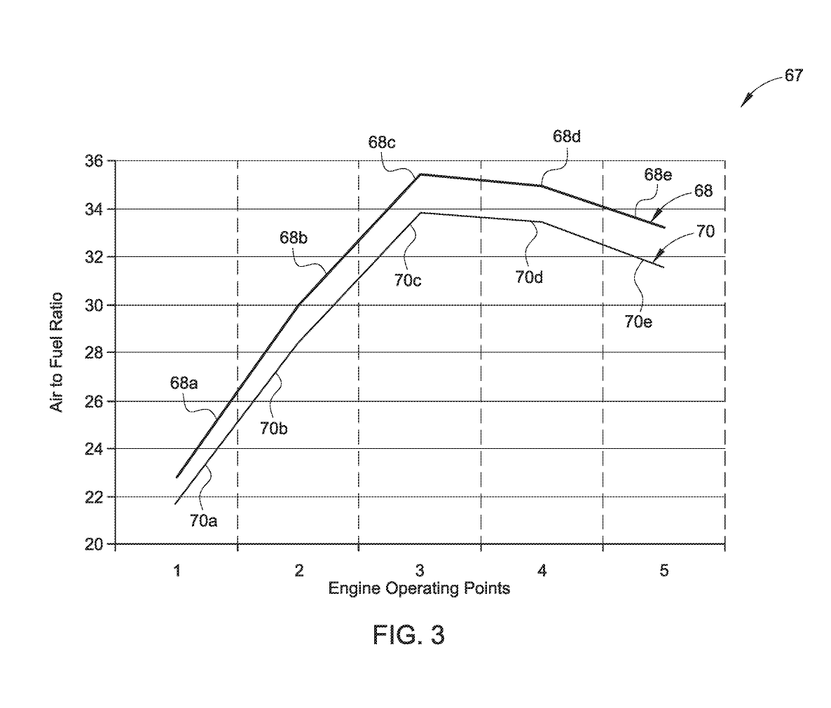

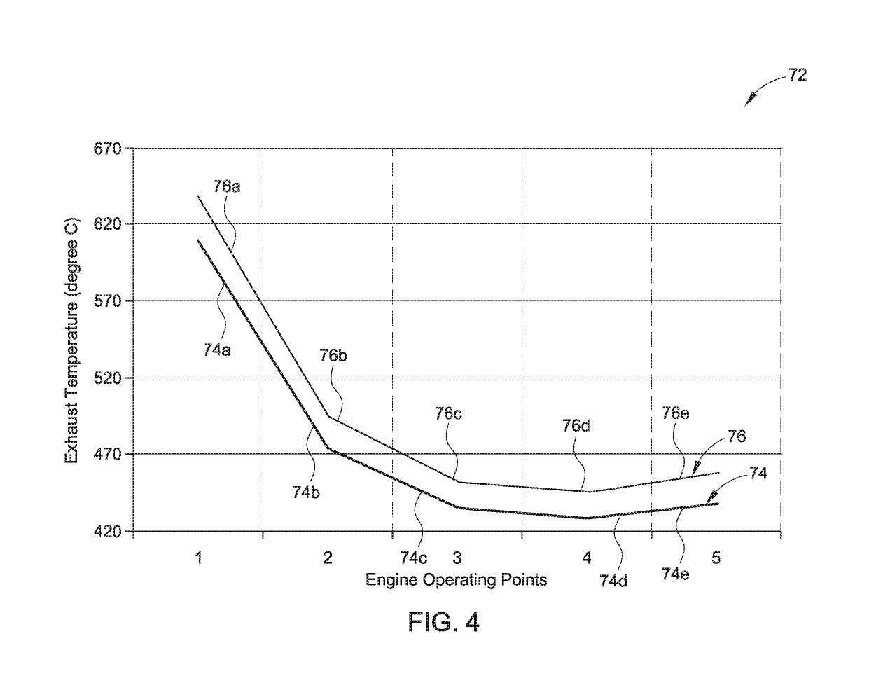

In operation, the camshaft 22 of the engine 12 controls actuation of the intake valves 40 of the donor cylinders 38 according to the late-closing CAM cycle. The present disclosure discloses the modified CAM tuning that is implemented for use in conjunction with each of the donor cylinders 38. The modified CAM timing of the intake valves 40 of the donor cylinders 38 is longer in duration as compared to the CAM timing of the intake valves 46 associated with the non-donor cylinders 44. The intake valves 40 of the donor cylinders 38 therefore remain open for a longer duration of time as compared to the intake valves 46 associated with the non-donor cylinders 44, thereby causing an increased amount of air to flow inside the donor cylinders 38 until both the cylinders banks 18, 20 receive a uniform amount of air. The modified CAM timing for the intake valves 40 of the donor cylinders 38 may be achieved by merely configuring the individual lobes of the camshaft 22 thus reducing cost and effort typically required to improve engine performance in reducing emissions. Further, this reduces a need for complex electronic control that would otherwise entail added costs to manufacturers of engines. The modified CAM timing of the intake valve 40 associated with the donor cylinder 38 also improves other operating parameters of the engine 12, explanation to which will be made in conjunction with FIGS. 3 and 4 respectively.

FIGS. 3-4 show graphs that are included for illustrative purposes only to graphically compare different performance profiles of the donor cylinder 38 with the disclosed donor intake lobe that operates based on the modified CAM timing and a typical donor cylinder (not shown) with a conventional donor intake lobe (not shown) that operates based on the conventional CAM timing.

FIG. 3 shows a graph 67 that depicts comparison of air-fuel ratios (AFR) in the donor cylinder 38 and the AFRs in the typical donor cylinder. A horizontal axis of the graph 67 shows multiplicity of engine operating points of the engine 12. A vertical axis of the graph 67 represents multiplicity of AFRs for the donor cylinder 38. The graph 67 plots a first AFR response curve 68 and a second AFR response curve 70. The first AFR response curve 68 depicts multiplicity of AFRs associated with the donor cylinder 38 using the donor intake lobe, which opens the intake valve 40 based on the modified CAM timing. The first AIR response curve 68 includes curve portions 68a, 68h, 68c, 68d, and 68e corresponding to engine operating points 1, 2, 3, 4, and 5, respectively. The second AFR response curve 70 depicts multiplicity of AFRs associated with the typical donor cylinder using the conventional donor intake lobe, which opens an intake valve (not shown) based on the conventional CAM timing. The second AFR response curve 70 includes curve portions 70a, 70b, 70c, 70d, and 70e corresponding to the engine operating points 1, 2, 3, 4, and 5. respectively. The donor intake lobe with the modified CAM timing enables the intake valves 40 to allow increased flow of air into the donor cylinders 38, and hence, increases the AFRs in the donor cylinders 38. It may be seen from the graph 67 that the curve portions 68a, 68b, 68c, 68d, and 68e respectively, are above the curve portions 70a, 70b, 70c, 70d, and 70e, reflecting an overall AFR increase of 0.3 to 0.7 units for the engine 12. This implies that due to the increased flow of air into the donor cylinder 38, the AFRs in the donor cylinder 38 using the disclosed donor intake lobe, are greater than the AFRs in the typical donor cylinder with the conventional donor intake lobe. Further, this also causes an increase in an internal AFR ratio of the first cylinder hank 18, which includes the donor cylinders 38. The AFR increase shown in the graph 67 is for illustrative and explanative purpose only. Hence, the AFR increase is not limited to values shows in the graph 67.

FIG. 4 shows a graph 72 comparing exhaust temperatures generated in the donor cylinder 38 using the disclosed donor intake lobe and the exhaust temperatures generated in the typical donor cylinder using the conventional donor intake lobe. A horizontal axis of the graph 72 represents the engine operating points 1, 2, 3, 4, and 5 of the engine 12. A vertical axis of the graph 72 represents the exhaust temperatures. The graph 72 includes a first temperature curve 74 and a second temperature curve 76, plotted along multiple engine operating points 1, 2, 3, 4, and 5. The first temperature curve 74 represents the exhaust temperatures generated in the donor cylinder 38 across the engine operating points 1, 2, 3, 4, and 5. The exhaust temperatures are generated based on the flow of air to the donor cylinder, by opening the intake valve 40 via the donor intake lobe. The first temperature curve 74 includes curve portions 74a, 74b, 74c, 74d, and 74e, depicting exhaust temperatures during the engine operating points 1, 2, 3, 4, and 5, respectively. Similarly, the second temperature curve 76 represents the exhaust temperatures generated in the typical donor cylinder across the engine operating points 1, 2, 3, 4, and 5. The exhaust temperatures are generated based on the flow of air to the typical donor cylinder, by opening the intake valve via the conventional donor intake lobe. The second temperature curve 76 includes curve portions 76a, 76b, 76c, 76d, and 76e, depicting exhaust temperatures in the typical donor cylinder resulting from the intake valve during the engine operating points 1, 2, 3, 4, and 5, respectively. It may be noted that the disclosed donor intake lobe actuates the intake valve 40 to open for a longer intake duration as compared to the intake duration for which the conventional donor intake lobe actuates the intake valve. This results in increased flow of air into the donor cylinder 38 as compared to that into the typical door cylinder. Hence, due to the increased flow of air, the exhaust temperatures in the donor cylinder 38 are lower than the exhaust temperatures in the typical donor cylinder. This can be evidently seen in the graph 72, where the curve portions 74a, 74b, 74c, 74d, and 74e respectively, are below the curve portions 76a, 76b, 76c, 76d, and 76e. Hence, the exhaust temperatures in the donor cylinder 38 using the disclosed donor intake lobe are approximately 20-25 degrees lesser than the exhaust temperatures in the typical donor cylinder using the conventional donor intake lobe. This may also result in shifting of the exhaust temperature substantially close to cylinder temperature of the non-donor cylinder 44. In addition, an EGR inlet temperature also reduces with reduction in the exhaust temperature. Hence, there is no requirement of additional cooling which was typically required with previously known systems to reduce the high EGR inlet temperature. In addition, exhaust emissions from the donor cylinders 38 may also reduce due to the increased mass flow rate of air to the donor cylinders 38. Further, it may be noted that difference between the exhaust temperature of the donor cylinder 38 and the typical donor cylinder, shown in the graph 72, is for illustrative and explanative purpose only. Hence, the difference between the exhaust temperatures is not limited to values shows in the graph 72.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of the disclosure. Such embodiments should be understood to fall within the scope of the present disclosure as determined based upon the claims and any equivalents thereof.

What is claimed is:

1. A multi-cylinder engine comprising:
a donor cylinder having an intake valve configured to operatively control a flow of air into the donor cylinder, the donor cylinder configured to fluidly communicate exhaust gases to an exhaust gas recirculation (EGR) system;
a non-donor cylinder including an intake valve configured to operatively control a flow of air into the non-donor cylinder;
at least one intake manifold configured to direct air into the donor cylinder and the non-donor cylinder, wherein the at least one intake manifold is disposed in fluid communication with the EGR system; and
at least one camshaft structured to:
control an opening and closing of the intake valve of the non-donor cylinder such that the intake valve of the non-donor cylinder is maintained open for a first intake duration; and
control an opening and closing of the intake valve of the donor cylinder such that the at least one intake valve of the donor cylinder is maintained open for a second intake duration greater than the first intake duration associated with the opening of the non-donor cylinder.
